(19) United States
(12) Patent Application Publication
(10) Pub. No.: US 2026/0021714 A1
(43) Pub. Date: Jan. 22, 2026

(54) BATTERY MOUNTING STRUCTURE

(71) Applicant: TOYOTA JIDOSHA KABUSHIKI KAISHA, Toyota-shi (JP)

(72) Inventor: Eiji YOSHIDA, Seto-shi (JP)

(73) Assignee: TOYOTA JIDOSHA KABUSHIKI KAISHA, Toyota-shi (JP)

(21) Appl. No.: 19/078,541

(22) Filed: Mar. 13, 2025

(30) Foreign Application Priority Data
Jul. 16, 2024 (JP) 2024-113173

(51) Int. Cl. B60L 50/64; B60K 1/04; B60L 50/60; B62D 21/15; H01M 50/242; H01M 50/249; H01M 50/262; H01M 50/271

(52) U.S. Cl. CPC B60L 50/64; B60K 1/04; B60L 50/66; B62D 21/157; H01M 50/242; H01M 50/249; H01M 50/262; H01M 50/271; B60K 2001/0438; H01M 2220/20

(57) ABSTRACT

A battery mounting structure includes a battery unit disposed under a vehicle floor and including a battery and a battery case accommodating the battery, and a side frame disposed outside the battery unit in a vehicle width direction, wherein the battery case includes a lower case, an upper case covering an upper end opening of the lower case from above, and a sealing portion that connects the lower case and the upper case to seal the battery case, and the sealing portion is positioned above an upper surface of the side frame.

### CROSS-REFERENCE TO RELATED APPLICATION

This application claims priority to Japanese Patent Application No. 2024-113173 filed on Jul. 16, 2024. The disclosure of the above-identified application, including the specification, drawings, and claims, is incorporated by reference herein in its entirety.

### BACKGROUND

### 1. Technical Field

The present specification discloses a battery mounting structure under a floor of a vehicle.

### 2. Description of Related Art

Hitherto, an electrified vehicle that travels with power of a traveling motor has been known. In such an electrified vehicle, a battery unit for supplying electric power to the traveling motor is mounted. The battery unit is often disposed under the floor of the vehicle. In general, a battery case that houses a battery is formed by combining a lower case and an upper case. Japanese Unexamined Patent Application Publication No. 2022-165717 (JP 2022-165717 A) discloses a battery unit including a lower case and an upper case.

### SUMMARY

In recent years, the battery unit has been upsized in order to secure a larger charging capacity. The clearance between the battery unit and the frame of the vehicle has decreased as the battery unit is upsized. In this case, there is a possibility that the battery unit may strike against the frame in the event of a side collision of the vehicle. In particular, there is a possibility that a shock is input to a sealing portion that is a coupling portion between the lower case and the upper case. In this case, the sealing of the sealing portion is lost and the battery in the battery case cannot be protected properly.

Therefore, the present specification discloses a battery mounting structure that can protect a battery unit more reliably.

A battery mounting structure disclosed in the present specification includes:
a battery unit disposed under a floor of a vehicle and including a battery and a battery case that houses the battery; and
a side frame disposed on an outer side of the battery unit in a vehicle width direction.

The battery case includes a lower case, an upper case that covers an upper end opening of the lower case from a top, and a sealing portion that seals the battery case by coupling the lower case and the upper case.

The sealing portion is located on a vehicle upper side with respect to an upper surface of the side frame.

In this case, the battery mounting structure may further include an inner shock absorbing member that absorbs a shock by being crushed and includes a vertical portion disposed between the side frame and the battery case.

The sealing portion may include a lower flange projecting outward from a peripheral edge of the lower case, and an upper flange projecting outward from a peripheral edge of the upper case and laid over the lower flange.

A dimension of the vertical portion in the vehicle width direction may be larger than a dimension of the sealing portion in the vehicle width direction. The sealing portion extends outward in the vehicle width direction from a side wall of the battery case.

In the battery mounting structure, the inner shock absorbing member may include the vertical portion and a lateral portion extending outward in the vehicle width direction from a lower end of the vertical portion.

The battery unit may include a base plate fixed to a bottom surface of the battery case and fastened to a bottom surface of the inner shock absorbing member.

The side frame may be placed on the lateral portion and fastened to the inner shock absorbing member with a clearance between the side frame and the vertical portion.

In the battery mounting structure, an angle of a side surface of the lower case with respect to a bottom surface of the lower case may be substantially 90°.

A shape of the side surface of the lower case with respect to the bottom surface of the lower case may be defined by roll forming.

In the battery mounting structure, a bottom surface of the battery unit may be located on a vehicle lower side with respect to a bottom surface of the side frame.

According to the technology disclosed in the present specification, the sealing portion is located on the upper side with respect to the upper surface of the side frame. Therefore, a strike between the sealing portion and the side frame in the event of a side collision is prevented effectively. As a result, damage to the sealing portion is prevented effectively and the battery unit is protected more reliably.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view around a battery unit;

FIG. 2 is a partially enlarged view of FIG. 1;

FIG. 3 is a cross-sectional view of the periphery of the battery unit at the time of side collision;

FIG. 4 is a diagram for explaining a relation between a configuration of a lower case and a mounting space of a battery; and

FIG. 5 is a cross-sectional view of a mounting structure of a comparative example.

### DETAILED DESCRIPTION OF EMBODIMENTS

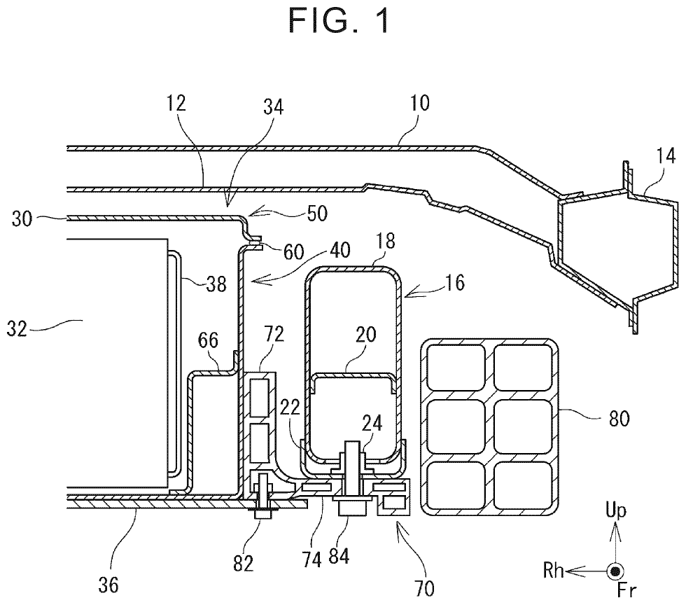

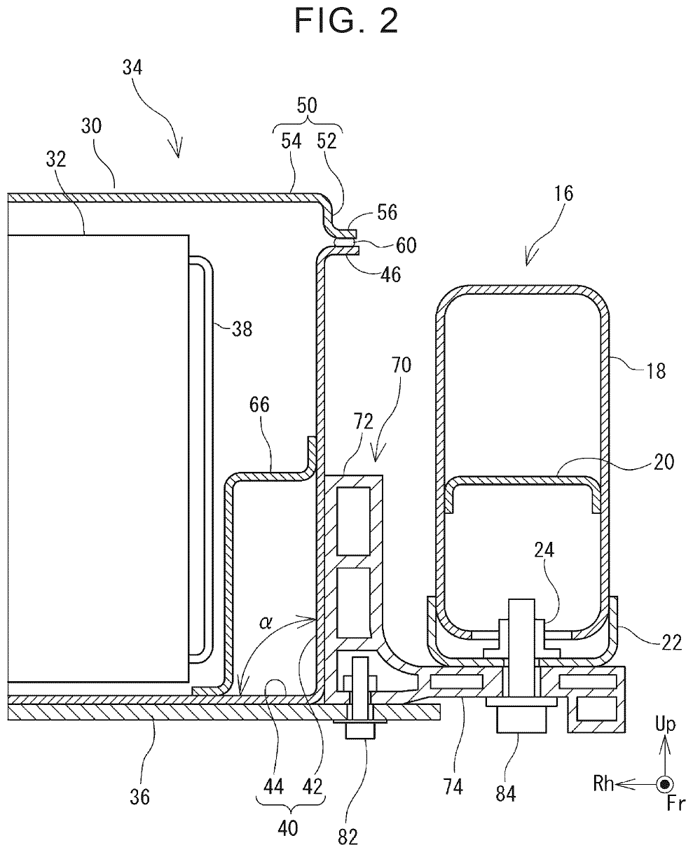

Hereinafter, a mounting structure of the battery 32 will be described with reference to the drawings. FIG. 1 is a cross-sectional view around the battery unit 30. FIG. 2 is a partially enlarged view of FIG. 1. FIG. 1 and FIG. 2 are cross-sectional views of the vehicle taken along a vertical plane parallel to the vehicle width direction, and the front side of the paper surface is the front side of the vehicle. Fr, Up, Rh in the drawings indicate the front, upper, and right sides of the vehicles, respectively.

In the following, a structure is disclosed in which the battery 32 is mounted on a frame vehicle in which the frame is independent of the body. However, the technology disclosed in this specification is not limited to a frame vehicle, and may be applied to a monocoque vehicle in which a frame and a body are integrated. In the present example, the battery unit 30 is disposed below the floor of the vehicle, that is, the floor panel 10 and the floor reinforcement 12. In the following explanation, “reinforcement” will be referred to as “RF”.

As shown in FIG. 1, both ends of the floor panel 10 in the vehicle width direction and both ends of the floor RF 12 in the vehicle width direction are joined to the rocker 14. The rockers 14 are members that are arranged one at each end in the vehicle width direction and extend in the vehicle front-rear direction.

A pair of side frames 16 and a battery unit 30 are disposed under the floor of the vehicle. The side frame 16 is a frame member extending in the vehicle front-rear direction. The pair of side frames 16 are disposed on both sides of the battery unit 30 in the vehicle width direction.

As shown in FIG. 2, the side frame 16 is roughly divided into a frame body 18, a frame RF 20, and fastening brackets 22. The frame body 18 is a cylindrical member having a substantially rectangular closed cross section, and is manufactured by, for example, extrusion molding. An opening through which the fastening bolt 84 passes is formed in the bottom surface of the frame body 18. The frame RF 20 is disposed in an inner space of the frame body 18. Both vehicle-width-direction ends of the frame RF 20 are joined to side surfaces of the frame body 18. As a result, the frame RF 20 divides the inner space of the frame body 18 into upper and lower portions, thereby improving the stiffness of the frame body 18.

The fastening bracket 22 is a panel member joined to the frame body 18 so as to cover the bottom surface of the frame body 18. A weld nut 24 is joined to a rear surface of the fastening bracket 22 (that is, a surface facing the bottom surface of the frame body 18). A fastening hole concentric with the weld nut 24 is formed in the fastening bracket 22.

The battery unit 30 supplies electric power to a traveling motor (not shown) of the vehicle. The battery unit 30 has a flat shape having a larger dimension in the vehicle width direction and a larger dimension in the front-rear direction than in the vertical direction. The battery unit 30 includes a battery 32, a battery case 34 that houses the battery 32, and a base plate 36. The battery 32 is a secondary battery that supplies electric power to a driving motor of the vehicle and stores electric power generated by the vehicle or supplied from outside the vehicle. The battery 32 is configured by electrically connecting a plurality of battery cells (not shown), for example. As shown in FIG. 2, a portion of the bus bar 38 that electrically connects the battery cells to each other extends in the vertical direction at an end portion of the battery 32 in the vehicle width direction.

The battery case 34 houses the battery 32. The battery case 34 includes a lower case 40 in which the battery 32 is accommodated, an upper case 50 that covers an upper end opening of the lower case 40, and a sealing portion 60. The lower case 40 is a substantially box-shaped member including a bottom wall 44 and a peripheral wall rising from a peripheral edge of the bottom wall 44. Hereinafter, the wall in the vehicle width direction of the peripheral wall of the lower case 40 is referred to as a “side wall 42”. A lower flange 46 extends horizontally outward from an upper edge of the peripheral wall including the side wall 42.

The angle α of the side wall 42 with respect to the bottom wall 44 is substantially 90 degrees. “Substantially 90 degrees” is an angle at which a draft angle is deemed to be absent. That is, in general, when molding using a mold, since a draft angle of 0.5 degrees or more is required, “substantially 90 degrees” means an angle difference between 90 degrees and less than 0.5 degrees. The reason why the angle α is substantially 90 degrees in this manner will be described later. In order to make the angle α of the side wall 42 with respect to the bottom wall 44 substantially 90 degrees, in the present example, the shape of the side wall 42 with respect to the bottom wall 44 is manufactured by roll forming.

A battery RF 66 is fixed inside the lower case 40. The battery RF 66 is a member for reinforcing the lower case 40, and is a member having a substantially L-shaped cross section. As shown in FIG. 2, one end of the battery RF 66 is joined to the side wall 42, and the other end thereof is joined to the bottom wall 44. As a result, a closed cross section is formed between the battery RF 66 and the bottom wall 44 and the side wall 42. The closed cross section improves the rigidity of the lower case 40.

The upper case 50 is a lid-like member including a top wall 54 and a peripheral wall depending from a peripheral edge of the top wall 54. Hereinafter, the wall in the vehicle width direction of the peripheral wall of the upper case 50 will be referred to as a “side wall 52”. An upper flange 56 extends horizontally outward from a lower edge of the peripheral wall including the side wall 52.

The upper flange 56 is superposed on the lower flange 46 and joined by a sealing agent or the like. The bonding portion is a sealing portion 60 that seals the battery case 34. The sealing portion 60 joins the upper flange 56 and the lower flange 46 without any gap therebetween. The battery case 34 is sealed by the sealing portion 60. As a result, intrusion of foreign matter including water into the battery case 34 is prevented. In addition, since the battery case 34 is sealed, air outside the case is less likely to enter into the case. As a result, it is possible to suppress a change in temperature and humidity around the battery 32.

Incidentally, as shown in FIG. 2, the sealing portion 60 is located above the upper end of the side frame 16. That is, the upper end of the lower case 40 is higher than the upper end of the side frame 16. Such a configuration is for preventing damage to the sealing portion 60, which will also be described later.

The base plate 36 is a plate material joined to the bottom wall 44 of the lower case 40. A portion of the base plate 36 protrudes outward in the vehicle width direction from the lower case 40. The base plate 36 and thus the battery unit 30 are fastened to the bottom surface of the inner shock absorbing member 70 by fastening bolts 82. In the following description, the “shock absorbing member” is referred to as an “EA member”.

As shown in FIG. 1, outer EA members 80 and inner EA members 70 are disposed on both left and right sides of the side frame 16. Each of the outer EA member 80 and the inner EA member 70 is a member that absorbs an impact by being actively collapsed when a vehicle-side collision occurs, and thereby protects a vehicle cabin or an in-vehicle component.

The outer EA member 80 is disposed on the vehicle-width-direction outer side of the side frame 16. The outer EA member 80 extends parallel to the side frame 16. As shown in FIG. 1, the inner space of the outer EA member 80 is divided into a vertical direction and a horizontal direction, and a plurality of small chambers are formed inside the outer EA member 80. The outer EA member 80 is formed by, for example, extrusion-molding or roll-molding.

The inner EA member 70 is disposed on the vehicle-width-direction inner side of the outer EA member 80. The inner EA member 70 also extends parallel to the side frame 16. As illustrated in FIG. 2, the inner EA member 70 includes a vertical portion 72 and a lateral portion 74 extending from the lower end of the vertical portion 72 to the vehicle-width-direction outer side. The vertical portion 72 is located between the battery unit 30 and the side frame 16. The lateral portion 74 is located below the side frame 16. The inner space of the inner EA member 70 is also partitioned in the up-down direction and the left-right direction, and a plurality of small chambers are formed inside the inner EA member 70. The inner EA member 70 is formed by, for example, extrusion-molding or roll-molding.

The base plate 36 described above is fastened to the bottom surface of the vertical portion 72 by fastening bolts 82. The side frame 16 is fastened to the inner EA member 70 by the fastening bolts 84 while being placed on the lateral portion 74. Therefore, the bottom surface of the battery unit 30 is lower than the bottom surface of the side frame 16. Further, as shown in FIG. 2, the vertical portion 72 of the inner EA member 70 forms a slight gap with the side frame 16 and is disposed at a position close to the side wall 42 of the lower case 40. With this arrangement, the lateral portion 74 collapses during the side projection until the side frame 16 reaches the vertical portion 72. Since the impact energy is consumed by the collapse of the lateral portion 74, the impact transmitted to the vertical portion 72 and thus the battery unit 30 can be reduced.

Further, the upper surface of the vertical portion 72 is positioned at substantially the same height as the upper surface of the battery RF 66 and the frame RF 20. With this arrangement, it is possible to suppress the damage of the battery case 34 at the time of side collision. Further, the vehicle width direction dimension of the vertical portion 72 is larger than the vehicle width direction dimension of the scaling portion 60. The reason for this configuration will be described later.

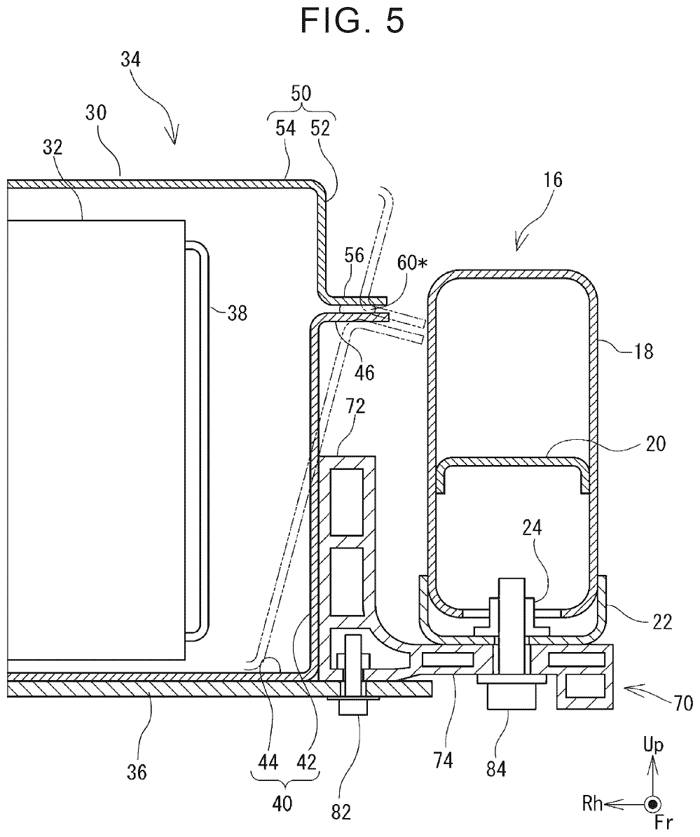

Next, the reason for the above-described configuration will be described in comparison with the comparative example. FIG. 5 is a diagram illustrating a mounting structure of a comparative example. In the comparative example shown in FIG. 5, the scaling portion 60* is located lower than the upper surface of the side frame 16. The vehicle width direction dimension of the sealing portion 60* is larger than the vehicle width direction dimension of the vertical portion 72 of the inner EA member 70.

In such a configuration, there is a possibility that the sealing portion 60* collides with the side frame 16 at the time of side collision, and the sealing in the scaling portion 60* is released. That is, in a case where a side collision occurs, the side frame 16 is subjected to an impact and moves inward in the vehicle width direction. On the other hand, the battery unit 30 rolls relatively outward in the vehicle width direction due to the inertial force. As a result, the battery case 34 is inclined as indicated by a two-dot chain line in FIG. 5. At this time, when the sealing portion 60* is lower than the upper surface of the side frame 16, the scaling portion 60* easily collides with the side frame 16.

Further, even when the battery unit 30 does not roll, the scaling portion 60* is likely to collide with the side frame 16 that has moved inward in the vehicle width direction. In particular, when the vehicle width direction dimension of the sealing portion 60* is larger than the vehicle width direction dimension of the vertical portion 72 of the inner EA member 70, the scaling portion 60* collides with the side frame 16 prior to the inner EA member 70 being collapsed.

Then, the sealing portion 60* strongly collides with the side frame 16, so that the sealing portion 60* is damaged and the sealing is released. As a result, a large amount of external air flows into the battery case 34, and the humidity and temperature around the battery 32 suddenly change. In addition, depending on the surrounding conditions of the battery unit 30, foreign matters such as water and dust may enter the battery case 34 from a portion where the sealing is released.

Incidentally, by increasing the gap from the side wall 42 to the side frame 16, it is possible to prevent the collision between the sealing portion 60* and the side frame 16 to some extent. However, in order to increase the gap from the side wall 42 to the side frame 16, it is necessary to reduce the dimension of the battery unit 30 in the vehicle width direction. In this case, another problem arises in that the charge capacity of the battery 32 decreases as the physique of the battery unit 30 decreases. That is, in the case of the comparative example in which the sealing portion 60* is located below the upper surface of the side frame 16, there is a problem that the sealing portion 60* is damaged at the time of side projection, or the charging capacity needs to be lowered in order to prevent damage.

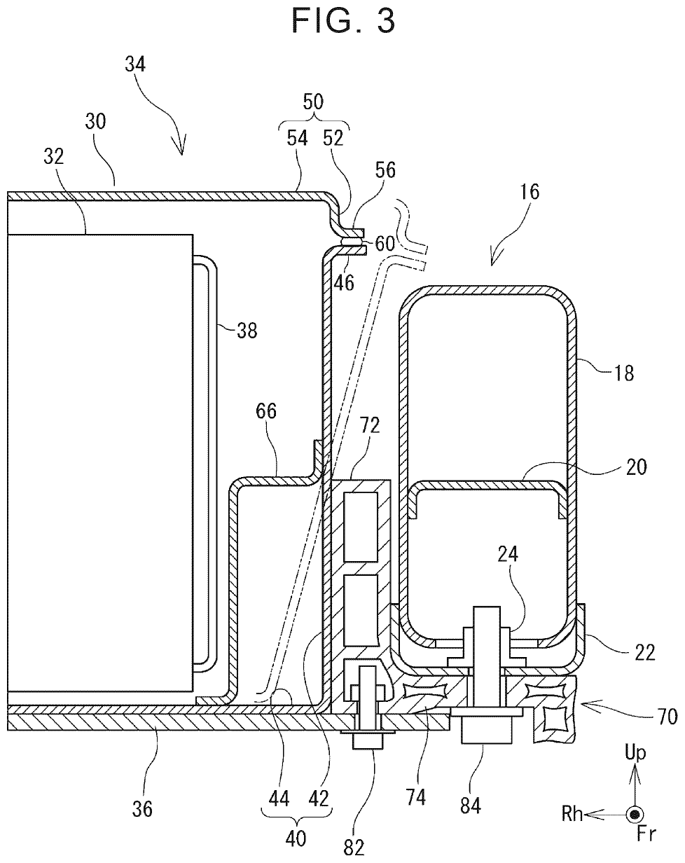

On the other hand, in the battery case 34 of the present example, as described above, the scaling portion 60 is positioned above the upper surface of the side frame 16. In this case, it is assumed that the battery 32 is inclined toward the side frame 16 along with the side projection. In this case, the battery case 34 is inclined as indicated by a two-dot chain line in FIG. 3, but the sealing portion 60 is separated from the side frame 16 and does not easily collide with the side frame 16.

Further, even when the battery unit 30 is not tilted, the side frame 16 moves inward in the vehicle width direction, that is, in a direction approaching the battery unit 30. At this time, since the sealing portion 60 is positioned above the upper surface of the side frame 16, collision between the sealing portion 60 and the side frame 16, and consequently, damage to the sealing portion 60 is effectively prevented. Further, as described above, in the present embodiment, the vehicle width direction dimension of the vertical portion 72 of the inner EA member 70 is made larger than the vehicle width direction dimension of the sealing portion 60. Therefore, before the side frame 16 collides with the battery unit 30, the vertical portion 72 is crushed and impact energy is consumed. Accordingly, even if the side frame 16 collides with the battery unit 30, the impact transmitted to the battery unit 30 is reduced, and thus the battery unit 30 including the sealing portion 60 is appropriately protected.

As is obvious from the above description, in the present example, since the sealing portion 60 is disposed above the upper surface of the side frame 16, it is possible to effectively prevent damage to the sealing portion 60 at the time of side projection. In particular, even if the battery case 34 is brought close to the side frame 16, the sealing portion 60 can be prevented from being damaged, so that the size of the battery unit 30 can be increased, and thus a large battery charging capacity can be secured. Further, in the case of the present example, since the position of the sealing portion 60 is increased, of course, the distance from the road surface to the sealing portion 60 is also increased. This effectively prevents mud or stone from adhering to the sealing portion 60.

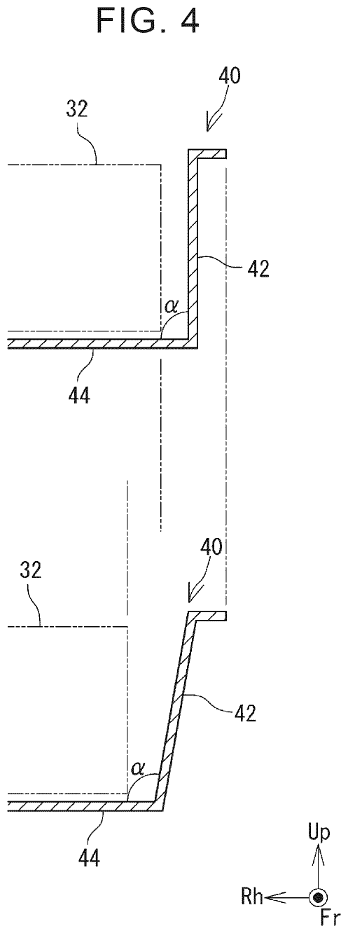

In the present example, the sealing portion 60 is positioned above the upper surface of the side frame 16, while the bottom surface of the battery unit 30 is positioned below the bottom surface of the side frame 16. With this configuration, the thickness of the battery unit 30 can be sufficiently secured, and a large battery charging capacity can be secured. However, in this case, the vertical dimension of the lower case 40 increases. In such a case, when the side wall 42 is inclined, the storage space of the battery 32 is reduced. This will be described with reference to FIG. 4.

FIG. 4 is a schematic diagram showing a comparison between a lower case 40 manufactured by roll molding and a lower case 40 manufactured by press molding. As is well known, in the case of press forming, a slight draft angle is required on the side of the product in order to remove the product from the mold. Usually, the draft angle is not less than 0.5 degrees. Therefore, when the lower case 40 is manufactured by press molding, the angle α of the side wall 42 with respect to the bottom wall 44 is 90.5 degrees or more. Here, when the vertical dimension of the side wall 42 is small, the inclination of the side wall 42 due to such draft angle is almost no problem. However, as shown in the lower drawing of FIG. 4, when the vertical dimension of the lower case 40 increases, the side wall 42 takes up space in the vehicle width direction by that amount. As a result, the vehicle width direction dimension of the battery 32 that can be disposed in the lower case 40 and thus the battery charging capacity are reduced.

Therefore, in the present example, the angle α of the side wall 42 with respect to the bottom wall 44 is substantially 90 degrees. Since such an angle is difficult to obtain by press forming, in the present example, the lower case 40 is manufactured by roll forming the shapes of the bottom wall 44 and the side wall 42. Roll forming is a technique for forming a steel sheet by passing a steel sheet between rollers in which a plurality of frames are arranged and bending the steel sheet stepwise.

When the angle α is substantially 90 degrees, the space occupied by the side wall 42 is reduced as shown in the upper part of FIG. 4. Accordingly, it is possible to effectively prevent a decrease in the vehicle width direction dimension of the battery that can be disposed in the lower case 40 and thus the battery charging capacity.

Note that the configuration described above is an example, and other configurations may be changed as long as the configuration of claim 1 is provided. For example, in the above-described example, the angle α of the side wall 42 with respect to the bottom wall 44 of the lower case 40 is substantially 90 degrees. However, the angle α may be a larger angle, or the shape of the bottom wall 44 and the side wall 42 may be manufactured by press forming. In addition, as long as the sealing portion 60 is positioned above the upper surface of the side frame 16, the dimension in the vehicle width direction may be larger than the dimension in the vehicle width direction of the vertical portion 72. Further, the bottom surface of the battery unit 30 may be positioned lower than the bottom surface of the side frame 16. Furthermore, in the previous discussion, an inner EA member 70 and an outer EA member 80 are provided. However, as long as EA member is disposed between the battery unit 30 and the side frame 16, the numbers, shapes, and arrangements of EA members may be changed as appropriate.

What is claimed is:

1. A battery mounting structure comprising:
a battery unit disposed under a floor of a vehicle and including a battery and a battery case that houses the battery; and
a side frame disposed on an outer side of the battery unit in a vehicle width direction, wherein
the battery case includes a lower case, an upper case that covers an upper end opening of the lower case from a top, and a sealing portion that seals the battery case by coupling the lower case and the upper case, and
the sealing portion is located on a vehicle upper side with respect to an upper surface of the side frame.

2. The battery mounting structure according to claim 1, further comprising an inner shock absorbing member that absorbs a shock by being crushed and includes a vertical portion disposed between the side frame and the battery case, wherein
the sealing portion includes a lower flange projecting outward from a peripheral edge of the lower case, and an upper flange projecting outward from a peripheral edge of the upper case and laid over the lower flange, and
a dimension of the vertical portion in the vehicle width direction is larger than a dimension of the sealing portion in the vehicle width direction, the sealing portion extending outward in the vehicle width direction from a side wall of the battery case.

3. The battery mounting structure according to claim 2, wherein:
the inner shock absorbing member includes the vertical portion and a lateral portion extending outward in the vehicle width direction from a lower end of the vertical portion;
the battery unit includes a base plate fixed to a bottom surface of the battery case and fastened to a bottom surface of the inner shock absorbing member; and
the side frame is placed on the lateral portion and fastened to the inner shock absorbing member with a clearance between the side frame and the vertical portion.

4. The battery mounting structure according to claim 1, wherein:
an angle of a side surface of the lower case with respect to a bottom surface of the lower case is substantially 90°; and
a shape of the side surface of the lower case with respect to the bottom surface of the lower case is defined by roll forming.

5. The battery mounting structure according to claim 1, wherein a bottom surface of the battery unit is located on a vehicle lower side with respect to a bottom surface of the side frame.
